(19) United States
(12) Patent Application Publication
(10) Pub. No.: US 2022/0205471 A1
(43) Pub. Date: Jun. 30, 2022

(54) LOCKING FEATURE FOR A FASTENER

(71) Applicant: Dana Automotive Systems Group, LLC, Maumee, OH (US)

(72) Inventors: Christopher L. FLOWERS, Humboldt, TN (US); Dalton A. TEETER, Paris, TN (US)

(21) Appl. No.: 17/453,134

(22) Filed: Nov. 1, 2021

Related U.S. Application Data
(60) Provisional application No. 63/131,718, filed on Dec. 29, 2020.

(51) Int. Cl. F16B 39/34

(52) U.S. Cl. CPC F16B 39/34

(57) ABSTRACT

Methods and systems are provided for a retention system. In one example, the retention system comprises a retention feature arranged in each of a molded element and a fastener. The retention features interface with one another to enhance operation of the fastener.

### CROSS REFERENCE TO RELATED APPLICATION

The present application claims priority to U.S. Provisional Application No. 63/131,718, entitled “LOCKING FEATURE FOR A FASTENER”, and filed on Dec. 29, 2020. The entire contents of the above-listed application are hereby incorporated by reference for all purposes.

### TECHNICAL FIELD

The present description relates generally to a locking feature for a fastener.

### BACKGROUND AND SUMMARY

Two or more materials may be joined together via a plurality of techniques, including but not limited to welds, adhesives, and fasteners. Materials fastened together may be fastened via one or more fasteners. A fastener may include a piece of hardware that mechanically affixes two or more materials together. Types of fasteners may include nails, bolts, screws, and rivets.

A longevity and/or ability of fastening materials may be improved by distributing a load evenly while also reducing fastener fatigue. Some examples include a grommet and a bushing. It is desired to have a sufficient amount of load to maintain a coupling between the materials. However, an interface between the fastener and the load distributor may weaken over time, resulting in undesired separation between the materials. This may be true for composite materials, such as plastics, which may be desired over other materials due to lower manufacturing costs and simpler manufacturing practices relative to alloys and other metals. Thus, a demand for an improved interface between a fastener and a load distributor still exists.

In one example, the issues described above may be addressed by a system for a retention feature of a molded element configured to interface with an undercut of a fastener. In this way, the retention feature may increase a pull out load of the fastener, thereby reducing undesired separation between materials and vibrational impacts on the fastener.

As one example, the retention feature comprises a protrusion extending around a circumference of the pin. The retention feature presses against a portion of the fastener. In one example, additionally or alternatively, the fastener may comprise a complementary feature configured to engage with the retention feature, such as a notch.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 illustrates a receiving element comprising a retention feature configured to receive a fastener.

FIG. 2 illustrates a schematic of a fastener inserted into a receiving element.

FIG. 3 illustrates an optional embodiment of the fastener.

FIG. 4 illustrates a cross-sectional view of a fastener partially inserted into a receiving element.

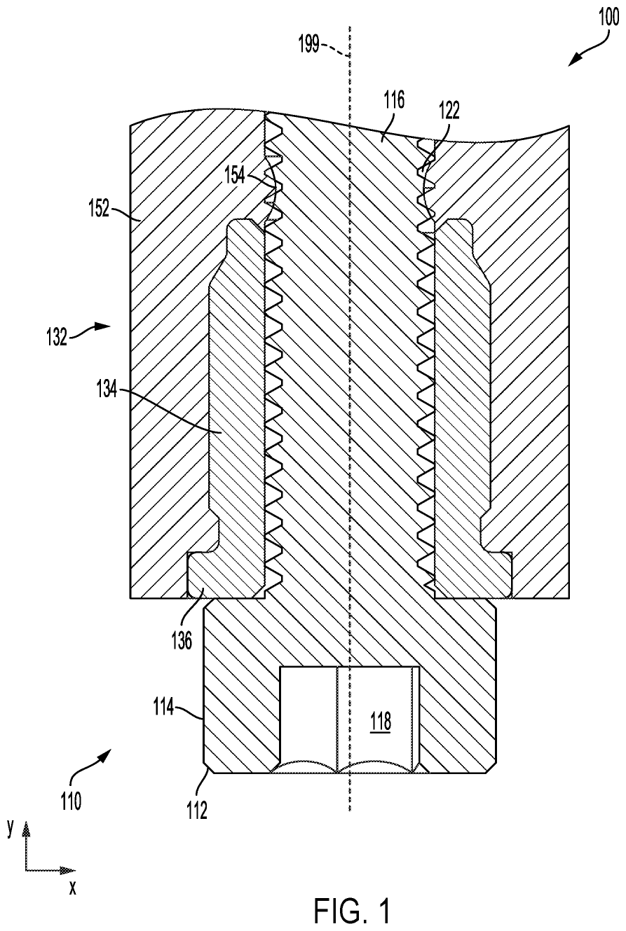

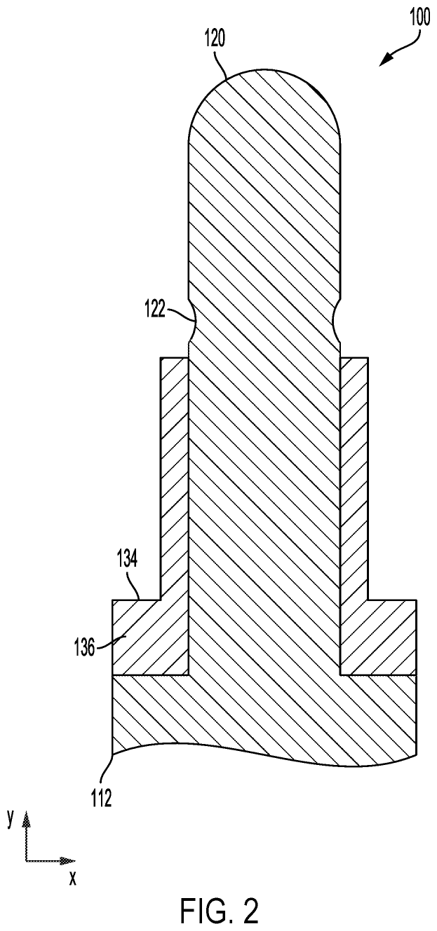

FIGS. 1 and 2 are shown to scale, however, other relative dimensions may be used if desired.

### DETAILED DESCRIPTION

The following description relates to a robust retention feature molded into a receiving element. The receiving element is configured to receive a fastener. In some examples, the fastener may comprise a shape complementary to the receiving element such that the fastener comprises a channel or the like for receiving the retention feature. Examples of the fastener and the receiving element are illustrated in FIGS. 1-4.

FIGS. 1-4 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. It will be appreciated that one or more components referred to as being “substantially similar and/or identical” differ from one another according to manufacturing tolerances (e.g., within 1-5% deviation).

Turning now to FIG. 1, it shows an embodiment 100 of a fastening system 110. The fastening system 110 may include a fastener 112 and a receiving element 132. The fastener 112 may include a head portion 114 and a body portion 116. A width of the head portion 114, measured along an x-axis, may be greater than a width of the body portion 116. The head portion 114 may further include a recess 118 configured to mate with a torqueing device to fasten the fastener 112 to the receiving element 132. In one example, the fastener 112 is a bolt and the recess 118 is configured to receive a hexagon shape tool, such as an allen key wrench. Additionally or alternatively, the recess 118 may be differently shaped and/or completely omitted without departing from the scope of the present disclosure.

The receiving element 132 comprises a threaded bore 134. The threaded bore 134 may be internally threaded such that helix-spiral of the treads extend radially inward toward an axis 199 along which the fastener 112 is inserted into the threaded bore 134. The body portion 116 may be complementary to the threaded bore 134 such that the body portion 116 is externally threaded and configured to lockingly engage with the threaded bore 134.

The threaded bore 134 may be surrounded by a molded element 152. The molded element 152 may circumferentially surround an entirety of the threaded bore 134. In one example, the molded element 152 is shaped such that the head portion 114 does not contact the molded element 152. That is to say, the threaded bore 134 may comprise a rim 136 configured to be in face-sharing contact with the head portion 114 when the fastener 114 is fully threaded into the threaded bore 134.

The molded element 152 may be further shaped to extend past the threaded bore 134 and interact with a portion of the body portion 116 of the fastener 112. At an interface between the molded element 152 and the body portion 116, there is a locking feature configured to increase a load used to remove the fastener 112. More specifically, the locking feature may include a protrusion 154 on the molded element 154 and a recess 122 on the body portion 116. The protrusion 154 and the recess 122 may be complementary to one another such that the recess 122 and the protrusion 154 are similarly shaped and sized. In this way, the protrusion 154 may extend into and be in face-sharing contact with the recess 122 when the fastener 112 is fully threaded through the threaded bore 134.

In one example, the protrusion 154 is an annular protrusion extending around an entire interior circumference of the molded element 152. The interior circumference may correspond to a portion of the molded element 152 extending a beyond the threaded bore 134. As such, the recess 122 may also comprise an annular shape, wherein the recess 122 is shaped as an indent or an undercut into the body portion 116 of the fastener 122. In some examples, additionally or alternatively, the protrusion 154 and the recess 122 may not be continuous. For example, the protrusions 154 and the recess 122 may be divided into a plurality of protrusions and recesses complementarily arranged such that the plurality of protrusions and recesses align in response to the fastener 112 being fully threaded through the threaded bore 134.

In the example of FIG. 1, the molded element 152 may comprise threading configured to mate with threaded of the fastener 122. In some examples, additionally or alternatively, the molded element 152 may be free of threading such that the molded element is smooth. In this way, the fastener 112 may only mate with the threaded bore 134 in some examples.

Turning now to FIG. 2, it shows an embodiment 200 of the fastener 112 and the threaded bore 134 without the molded element (e.g., molded element 152 of FIG. 1). As such, components previously introduced are similarly numbered in this figure and subsequent figures. The fastener 112 is fully threaded with the threaded bore 134 in the example of FIG. 2. As such, the head portion 114 is pressed against and in face-sharing contact with the rim 136. FIG. 2 is described in combination with respect to FIG. 1.

The recess 122 is arranged downstream of the threaded bore 134 relative to a direction in which the fastener 112 is inserted into the threaded bore 134. The fastener 112 further comprises a tooling pin 120 arranged at an extreme end of the fastener 112, opposite the head portion 114. The tooling pin 120 may include a curved shape. In the example of FIG. 2, the tooling pin 120 comprises a semi-circular cross-sectional shape. The body portion 116, between the recess 122 and the tooling pin 120, may be threaded or smooth. In the example of FIG. 2, the recess 122 is biased toward the portion of the body portion 116 interacting with the threaded bore 132 relative to the tooling pin 120. In one example, the body portion 116 is threaded throughout, and the recess 122 is an interference in the threading, wherein the recess 122 interfaces with the protrusion of the molded element 152.

The molded element (e.g., molded element 152 of FIG. 1) is shaped to encompass an entirety of an outer surface illustrated in FIG. 2. That is to say, exposed surfaces of the fastener 112 and the threaded bore 132 are completely covered via the molded element, excluding the head portion 114 of the fastener 112. In this way, the molded element is in face-sharing contact with the threaded bore 132, the body portion 116, the recess 122, and the tooling pin 120. The molded element may be spaced away from and does not contact the rim 136 and the head portion 114.

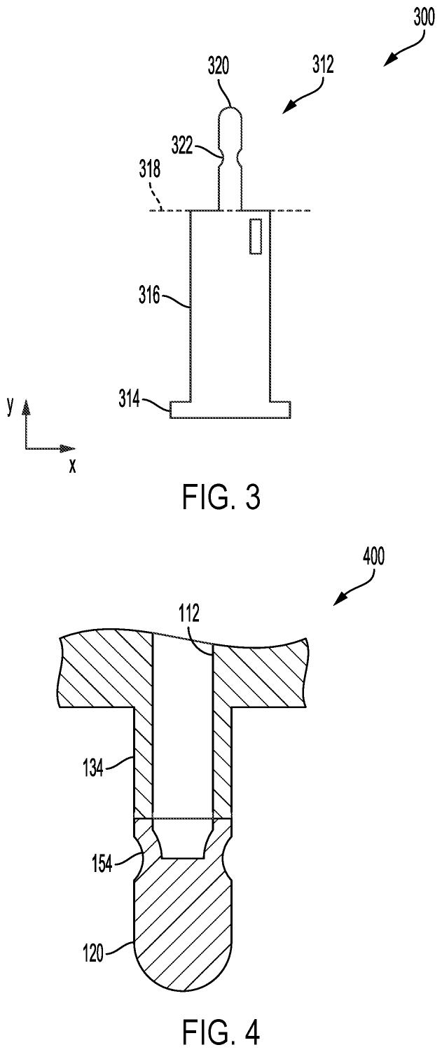

Turning now to FIG. 3, it shows an embodiment 300 of a fastener 312. The fastener 312 may be used similarly to the fastener 112 of FIGS. 1 and 2. The fastener 312 may include a head portion 314, a body portion 316, a recess 322, and a tooling pin 320, which may be similar to the head portion 114, the body portion 116, the recess 122, and the tooling pin 120, respectively. The fastener 312 may be differentiated from the fastener 112 based on a positioning of the recess 322 and inclusion of a guiding feature 332 in the body portion 316.

In the example of FIG. 3, the recess 322 may be arranged more evenly between the tooling pin 320 and a portion of the body portion 316 shaped to interact with a threaded bore. More specifically, in the example FIG. 3, the body portion 316 may comprise a first body portion and a second body portion, wherein axis 318 illustrates an imaginary transition point between the two. The first body portion is arranged proximally to the head portion 314 and comprises a first width, measured along the x-axis. The second body portion is arranged proximally to the tooling pin 320 and comprises a second width, smaller than the first width. In some examples, the second width is equal to 70%, or 50%, or 30% or less of the first width. The recess 322 is arranged along the second portion at a position directly between the tooling pin 320 and the axis 318.

Turning now to FIG. 4, it shows an embodiment 400 of the fastener 112 interacting with the protrusion 154. In the embodiment 400, a threaded portion of the fastener 112 is cut, to reveal inner and outer diameters of the fastener 112 interacting with the protrusion 154. More specifically, the protrusion 154 extends into an interior space between the threaded bore 134 and the tooling pin 120. The protrusion 154 may interact with threads of the fastener 112 similarly to the threaded bore 134 in that the protrusion 154 may engage with an inner diameter of the fastener 112 as outer diameter portions of the threaded portion of the fastener 112 extend therearound. As such, the protrusion 154 may not block the fastener 112 from being inserted into the tooling pin 120 in response to a rotational force being applied to the fastener 112.

In one example, a diameter of the protrusion 154 is less than at least the outer diameter of the threading of the fastener 112. Additionally or alternatively, the diameter of the protrusion 154 may be between the outer diameter and the inner diameter of the threading of the fastener 112. In one example, the diameter of the protrusion 154 corresponds to the inner diameter such that the protrusion 154 may be in face-sharing contact with inner diameter portions of the fastener 112. In one example, additionally or alternatively, the diameter of the protrusion 154 may be less than the inner diameter of the fastener 112, which may increase an insertion torque used to insert the fastener 112.

In this way, a retention system may comprise a molded element as a single piece configured to enhance an interaction between a fastener and a receiving element. The molded element comprises a retention feature configured to extend a fatigue life of the fastener while increasing a pull-out load. The molded element is molded as a single piece, and surrounds the receiving element and the fastener. The retention feature interfaces with an undercut of the fastener, thereby enhancing its retention.

The present disclosure further provides support for a system including a retention feature of a molded element configured to interface with an undercut of a fastener. A first example of the system further includes where the retention feature is an annular protrusion. A second example of the system, optionally including the first example, further includes where the undercut is a recess of the fastener. A third example of the system, optionally including one or more of the previous examples, further includes where the undercut is arranged on a threaded portion of the fastener. A fourth example of the system, optionally including one or more of the previous examples, further includes where the fastener comprises a head portion and a body portion. A fifth example of the system, optionally including one or more of the previous examples, further includes where the body portion comprises a uniform diameter. A sixth example of the system, optionally including one or more of the previous examples, further includes where the undercut corresponds to a reduction in the uniform diameter of the body portion. A seventh example of the system, optionally including one or more of the previous examples, further includes where the body portion comprises a first body portion and a second body portion, wherein a diameter of the first body portion is greater than a diameter of the second body portion. An eighth example of the system, optionally including one or more of the previous examples, further includes where the first body portion is threaded and the second body portion is free of threading. A ninth example of the system, optionally including one or more of the previous examples, further includes where the fastener comprises a tooling pin at an extreme end of the fastener opposite a head portion.

The present disclosure further provides support for a retention system including a molded element surrounding a receiving feature and a fastener, wherein the molded element comprises a retention feature configured to interface with an undercut of the fastener. A first example of the retention system further includes where the molded element comprises plastic. A second example of the retention system, optionally including the first example, further includes where the molded element encapsulates all of the receiving feature and the fastener except for a head portion of the fastener and a rim of the receiving feature. A third example of the retention system, optionally including one or more of the previous examples, further includes where the receiving feature comprises an internally threaded bore and the fastener comprises threads configured to engage with the internally threaded bore. A fourth example of the retention system, optionally including one or more of the previous examples, further includes where the undercut is arranged on a threaded portion of the fastener.

The present disclosure further provides support for a system including a retention feature of a molded element configured to interface with an undercut of a fastener, wherein the retention feature is an annular protrusion. A first example of the system further includes where the molded element comprises plastic, and wherein the molded element encapsulates all of the receiving feature and the fastener except for a head portion of the fastener and a rim of the receiving feature. A second example of the system, optionally including the first example, further includes where the fastener comprises a first body portion and a second body portion, wherein a diameter of the first body portion is greater than a diameter of the second body portion. A third example of the system, optionally including one or more of the previous examples, further includes where the first body portion is threaded and the second body portion is free of threading. A fourth example of the system, optionally including one or more of the previous examples, further includes where the fastener comprises a tooling pin at an extreme end of the fastener opposite a head portion.

Note that the example control and estimation routines included herein can be used with various engine and/or vehicle system configurations. The control methods and routines disclosed herein may be stored as executable instructions in non-transitory memory and may be carried out by the control system including the controller in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the engine control system, where the described actions are carried out by executing the instructions in a system including the various engine hardware components in combination with the electronic controller.

It will be appreciated that the configurations and routines disclosed herein are exemplary in nature, and that these specific embodiments are not to be considered in a limiting sense, because numerous variations are possible. For example, the above technology can be applied to V-6, I-4, I-6, V-12, opposed 4, and other engine types. The subject matter of the present disclosure includes all novel and non-obvious combinations and sub-combinations of the various systems and configurations, and other features, functions, and/or properties disclosed herein.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A system, comprising:
a retention feature of a molded element configured to interface with an undercut of a fastener.

2. The system of claim 1, wherein the retention feature is an annular protrusion.

3. The system of claim 1, wherein the undercut is a recess of the fastener.

4. The system of claim 1, wherein the undercut is arranged on a threaded portion of the fastener.

5. The system of claim 1, wherein the fastener comprises a head portion and a body portion.

6. The system of claim 5, wherein the body portion comprises a uniform diameter.

7. The system of claim 5, wherein the undercut corresponds to a reduction in the uniform diameter of the body portion.

8. The system of claim 5, wherein the body portion comprises a first body portion and a second body portion, wherein a diameter of the first body portion is greater than a diameter of the second body portion.

9. The system of claim 8, wherein the first body portion is threaded and the second body portion is free of threading.

10. The system of claim 1, wherein the fastener comprises a tooling pin at an extreme end of the fastener opposite a head portion.

11. A retention system, comprising:
a molded element surrounding a receiving feature and a fastener, wherein the molded element comprises a retention feature configured to interface with an undercut of the fastener.

12. The retention system of claim 11, wherein the molded element comprises plastic.

13. The retention system of claim 11, wherein the molded element encapsulates all of the receiving feature and the fastener except for a head portion of the fastener and a rim of the receiving feature.

14. The retention system of claim 11, wherein the receiving feature comprises an internally threaded bore and the fastener comprises threads configured to engage with the internally threaded bore.

15. The retention system of claim 11, wherein the undercut is arranged on a threaded portion of the fastener.

16. A system, comprising:
a retention feature of a molded element configured to interface with an undercut of a fastener, wherein the retention feature is an annular protrusion.

17. The system of claim 16, wherein the molded element comprises plastic, and wherein the molded element encapsulates all of the receiving feature and the fastener except for a head portion of the fastener and a rim of the receiving feature.

18. The system of claim 16, wherein the fastener comprises a first body portion and a second body portion, wherein a diameter of the first body portion is greater than a diameter of the second body portion.

19. The system of claim 18, wherein the first body portion is threaded and the second body portion is free of threading.

20. The system of claim 16, wherein the fastener comprises a tooling pin at an extreme end of the fastener opposite a head portion.
